(19) United States
(12) Patent Application Publication
(10) Pub. No.: US 2025/0272502 A1
(43) Pub. Date: Aug. 28, 2025

(54) INTENTION READER

(71) Applicant: Gainsight, Inc., San Francisco, CA (US)

(72) Inventors: Alessandro Pedori, Forlimpopoli -FC (IT); Itai Marks, Tel Aviv (IL); Lior Harel, Herzliya (IL)

(21) Appl. No.: 18/878,925

(22) PCT Filed: Jul. 5, 2023
(86) PCT No.: PCT/US2023/069600

§ 371 Date: Dec. 26, 2024

Related U.S. Application Data
(60) Provisional application No. 63/358,241, filed on Jul. 5, 2022.

(51) Int. Cl. G06F 40/35; G06N 5/04

(52) U.S. Cl. CPC G06F 40/35; G06N 5/04

(57) ABSTRACT

A method for determining an intention encoded in a given text communication, the method comprising: receiving a written text; identifying test regexes comprised in the text that are usable to indicate an intention included in the text; determining degrees of entailment of the test regexes with intention indicator regexes (IIRs) comprised in a set of IRRs; and inferring the intention based on the determined degrees of entailment.

### RELATED APPLICATIONS

The present application claims the benefit under 35 U.S.C. 119(e) of U.S. Provisional Application 63/358,241 filed on Jul. 5, 2022, the disclosures of which are incorporated herein by reference.

### FIELD

Embodiments of the disclosure relate to providing a method for inferring an intention of a person from a textual communication that the person generates.

### BACKGROUND

Face to face human communications between people typically involve a complex, substantially simultaneous transmission of information between the people over a plurality of different communication channels. The channels may be acoustic, visual, physical, and/or olfactory. A transmission over each of the channels is generally characterized by a mix of features that configure the communication and may be required to understand the content of the communication.

For example, an acoustic communication may involve transmission of a string of vocalized words, nonverbal utterances and unfilled pauses, all of which may be colored by characterizing features of volume, tone, duration, and/or rate of occurrence. Different configurations of characterizing features can determine totally opposite meaning to a same transmitted string of words. A statement that a person makes accompanied by a visual gesture, such as smile may have an entirely different meaning than the same statement that the person accompanies with transmission of a frown. The visual channel, however, supports not only transmissions of consciously recognized facial gestures, such as the smile, that may last between about 0.5 to about 4 seconds, but also unconsciously registered micro-expressions that have durations that are less than 0.5 seconds. And a statement accompanied by a smile may also be accompanied by a micro expression indicating that the smile is disingenuous and the statement false.

The human brain-sensory systems are quite adept at cooperating to integrate the simultaneous multichannel transmissions common to face to face communications and use the features characterizing the transmissions to provide relatively robust, and often accurate assessments of intentions that elicit the communications. The ability to provide robust and accurate assessments however is degraded when some of the information that is normally transmitted in face to face communications is missing.

For example, written text transmitted via any of the various email and messaging services, is devoid of most of the information carried by the mix of communication channels actively available and used in face to face communications. As a result, it may be difficult, if at all possible, to infer advantageously accurate assessments of intentions from written text communications commonly used for example in business transactions.

### SUMMARY

An aspect of an embodiment of the disclosure relates to providing a system, hereinafter also referred to as an “Intention Reader” or simply “I-Read”, for inferring an intention encoded in a given written text communication.

In an embodiment I-Read comprises an optionally cloud based hub configured to receive textual communications and process a received communication to infer an intention associated with a topic, hereinafter also referred to as a “target topic”, that is a subject of the communication. The hub may comprise an “intention database” having a set of exemplary regexes, such as sequences of characters, word sequences, or sentences, which may be referred to as intention indicator regexes (IIRs), for each of a plurality of different target topics. Each of the IIRs for a given target topic may be classified as indicating a different intention, or different group of associated intentions, of a plurality of different intentions of interest associated with the target topic. I-Read optionally processes a textual communication to determine a target topic relevant to the communication and identify regexes, hereinafter also referred to as test regexes, in the text that may be associated with IIRs in the intention database. The I-Read infers an intension of the communication responsive to estimates of degrees of entailments of the test regexes and the IIRs with which the IIRs may be associated.

By way of example, a target topic may be a particular type of business proposition and the intention database may comprise a plurality of intention indicator regexes, IIRs, for the business proposition. A regex in the intention database associated with the type of business proposition may be classified as indicating, optionally one of two, different intentions—a positive intention, or a negative intention. A positive intention regex (P-IIR) indicates that a person who generated the regex has an intention to agree with or accept the business proposition. A negative intention regex (N-IIR) indicates that a person who generated the regex has an intention to disagree with or refuse the business proposition.

I-Read may identify test regexes in a text received by the hub that may be used to indicate an intention comprised in the text. Optionally test regexes in the text are identified by identifying regexes in the text that are similar to intention indicator regexes IIRs using any of various pattern matching algorithms. Optionally test regexes are identified using a neural network. To determine degree of entailment the hub may transform each of the identified test regexes and each of a selection of IIRs in the intention database associated with the target topic and relevant intention of interest into a corresponding embedding vector in a same embedding space. Optionally, the hub uses a language model neural net to provide the embedding. The hub processes the embedding vector determined for each test regex with the embedding vector determined for each selected indicator IIR to determine a degree of entailment for the test regex and the IIR. The hub may use a natural language inference model neural net to determine the degrees of entailment. The hub uses the entailments for the test regexes to determine an intention relevant to the target topic of a person who generated the text.

For example, for a written communication from a person regarding the business proposition noted above, the hub may determine a degree of entailment for each test regex in the communication with each of the positive and negative intention indicators P-IIR and N-IIR. The hub may use the degrees of entailment to determine if the person has an intention to agree with or accept the business proposition.

I-Read in accordance with an embodiment of the disclosure may comprise any combination of virtual and/or bare-metal processing and memory resources, data and/or executable instructions generically referred to as software, advantageous for supporting functionalities that I-Read provides. I-Read software for use in determining intentions encoded in written texts may be accessible for use in any of various configurations and may by way of example be downloadable for use to a local server, accessed as Software-as-a-Service (SaaS), a resource of an infrastructure-as-a-service (IaaS), or a resource of a platform-as-a-service (PaaS).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

Non-limiting examples of embodiments of the disclosure are described below with reference to figures attached hereto that are listed following this paragraph. Identical structures, elements or parts that appear in more than one figure are generally labeled with a same numeral in all the figures in which they appear. A label labeling an icon representing a given feature in a figure of an embodiment of the disclosure may be used to reference the given feature. Dimensions of components and features shown in the figures are chosen for convenience and clarity of presentation and are not necessarily shown to scale.

FIGS. 1A and 1B show a flow diagram illustrating operation of an I-Read, in determining an intention of a written text, in accordance with an embodiment of the disclosure.

### DETAILED DESCRIPTION

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily a required configuration of possible embodiments of the disclosure. Unless otherwise indicated, the word “or” in the description and claims is considered to be the inclusive “or” rather than the exclusive or, and indicates at least one of, or any combination of more than one of items it conjoins. Whereas features and actions of flow diagrams shown in the figures and discussed in the specification are presented and discussed substantially in a sequential order prescribed by sequential block numbers referencing blocks in the figures, actions presented in the blocks may be undertaken simultaneously or in orders that are not prescribed by the block numbers.

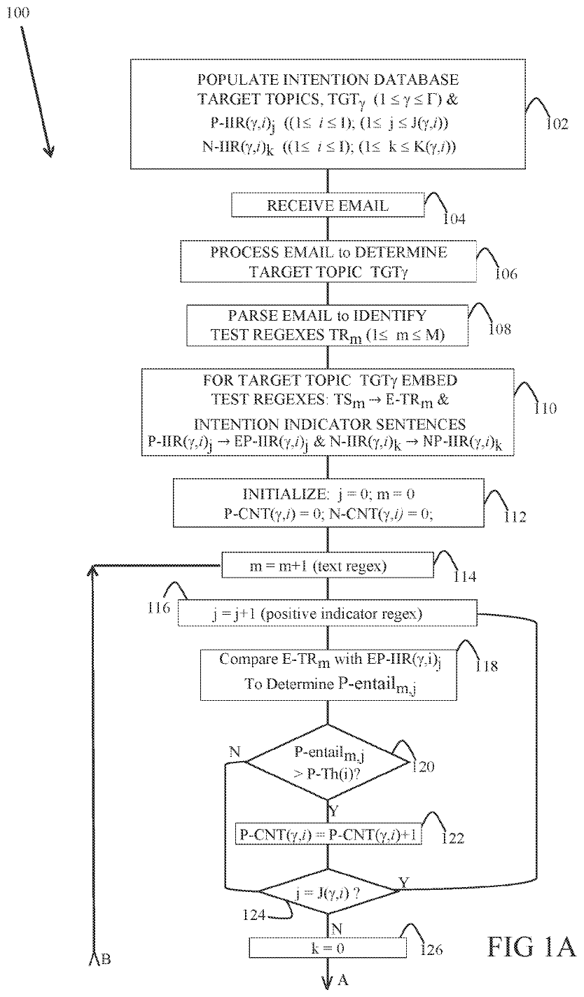

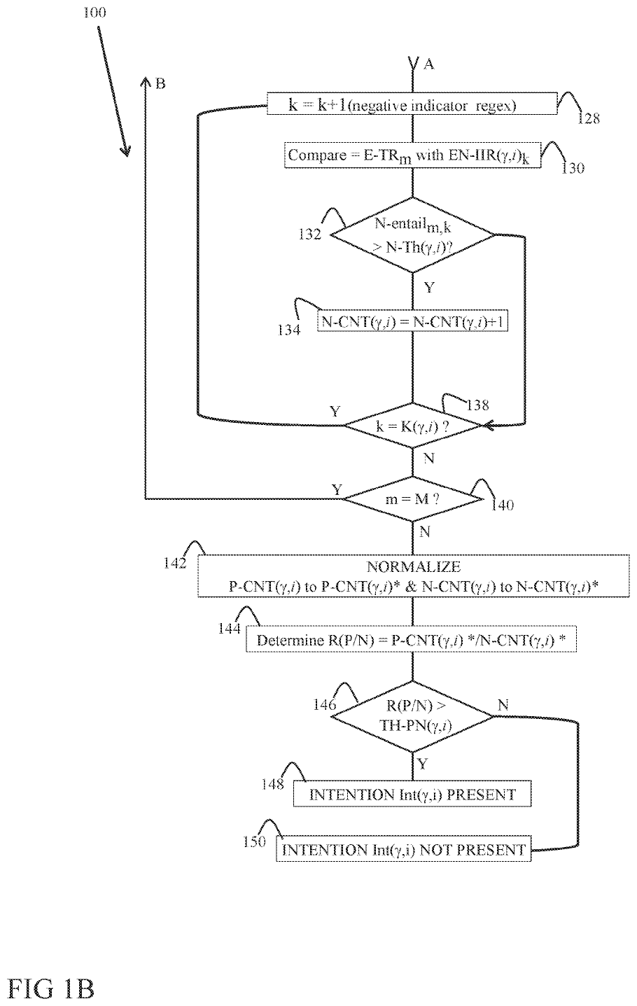

FIGS. 1A and 1B show a flow diagram 100 illustrating operation of an I-Read in determining an intention associated, optionally with an email text, in accordance with an embodiment of the disclosure.

Optionally, in a block 102 an intention database of the I-Read is populated with a plurality Γ of target topics TGT_{γ} (1≤γ≤Γ) of interest, and for each topic TGT_{γ} with a plurality I(γ) of different intentions Int(γ,i) (1≤i≤I(γ)) related to TGT_{γ}. For each TGT_{γ} and a related intention Int(γ,i) the intention database may be populated with a plurality J(γ,i) of positive intention indicator regexes P-IIR(γ,i)ⱼ (1≤j≤J(γ,i)) that may be considered to be indicative of the presence of the intention and a plurality K(γ,i) of negative intention indicator regexes N-IIR(γ,i)ₖ (1≤k≤K(γ,i)) that may be considered to indicate absence of the intention.

The intention database may be initialized with P-IIR(γ,i)ⱼ and N-IIR(γ,i)ₖ regexes that are determined to be positive or negative IIRs respectively by human judgement. Thereafter, a neural network trained using supervised learning to distinguish positive and negative IIRs may be used to classify regexes in texts as either P-IIR(γ,i) or N-IIR(γ,i) and the classified regexes added to the intention database. Optionally the P-IIR(γ,i)ⱼ and N-IIR(γ,i)ₖ regexes are determined using a neural network educated by a supervised or unsupervised learning procedure.

Optionally, in a block 104 I-Read may receive an email for processing to determine an intention of a person with respect to a particular target topic TGT_{γ} of interest and a given intention Int(γ,i) associated with the target topic. In a block 106 I-Read processes the email text, optionally using a neural network, to determine whether or not the email is directed to the particular target topic TGT_{γ}. In a block 108 I-Read parses the email to identify test regexes TR(γ,i)ₘ (1≤m≤M) associated with TGT_{γ} and intention Int(γ,i). In an embodiment, in a block 110 I-Read converts intention indicator regexes P-IIR(γ,i) or N-IIR(γ,i) and each test regex TR(γ,i)ₘ into corresponding embedding vectors EP-IIR(γ,i), EN-IIR(γ,i), and E-TR(γ,i)ₘ in a same embedding space. Optionally, I-Read uses a language model neural network to perform the embedding.

In a block 112 I-Read initializes counting variables j and m to zero and sets accumulators P-CNT(γ,i) and N-CNT(γ,i) to zero. In a block 114 I-Read increases counting variable m by 1 and in a block 116 increases counting variable j by one. Optionally, in a block 118 I-Read compares test embedding vector E-TR(γ,i)ₘ with positive indicator embedding vector EP-IIR(γ,i)ⱼ to determine a measure P-entail_{m,j} of a degree to which test regex E-TR(γ,i)ₘ is considered to entail positive intention indicator regex P-IIR(γ,i)ⱼ and thereby indicate presence of intention Int(γ,i). Any of various similarity classifiers, may be used to compare the embedding vectors to determine the measure P-entail_{m,j}. By way of example, a neural network or any of various clustering and distance classifiers may be used to compare the embedding vectors to determine the measure P-entail_{m,j}. Optionally, cosine similarity is used to perform the comparison.

In a decision block 120 I-Read determines whether P-entail_{m,j} is greater than an entailment positive threshold P-Th(γ,i) for target topic TGT_{γ} and intention Int(γ,i). If P-entail_{m,j} is greater than P-Th(γ,i) I-Read may proceed to a block 122 and increase positive accumulator P-CNT(γ,i) by one and continue to a decision block 124 to determine if j is equal to J(γ,i). If on the other hand P-entail_{m,j} is less than P-Th(γ,i) I-Read may proceed directly to decision block 124 to determine if j is equal to J(γ,i). If in decision block 124 I-Read determines that j is equal to J(γ,i), I-Read returns to block 116, increases counting variable j by one and again proceeds to block 118. Otherwise, I-Read proceeds to a block 126 to set counting variable k equal to zero.

I-Read may then proceed to a block 128 and increase counting variable k by one. Optionally, in a subsequent block 130 I-Read compares test embedding vector E-TR(γ,i)ₘ with negative indicator embedding vector EN-IIR(γ,i)ₖ to determine a measure N-entail_{m,k} of a degree to which test regex E-TR(γ,i)ₘ entails negative intention indicator regex N-IIR(γ,i)ₖ and thereby indicates absence of intention Int(γ,i). In an embodiment I-Read uses a same similarity classifier to determine negative entailment as I-Read uses to determine positive entailment.

In a decision block 132 I-Read determines whether N-entail_{m,k} is greater than a negative entailment threshold N-Th(γ,i) for target topic TGT_{γ} and intention Int(γ,i). If N-entail_{m,k} is greater than N-Th(γ,i) I-Read may proceed to a block 134 and increase negative accumulator N-CNT(γ,i) by one and continue to a decision block 138 to determine if k is equal to K(γ,i). If on the other hand N-entail_{m,k} is less than or equal to N-Th(γ,i) I-Read may proceed directly to block 138 to determine if k is equal to K(γ,i). If k is not equal to K(γ,i), I-Read returns to block 116, increases k by one and again proceeds to block 130. Otherwise, I-Read proceeds to a block 140 optionally to determine if m is equal to the total number M of test regexes identified in the received email.

If in block 140 m is determined to be less than M, I-Read optionally returns to block 114 to increase m by one and proceed again through blocks 116 to block 140. If on the other hand m is found to be equal to M in a block 142 I-Read normalizes P-CNT(γ,i) to P-CNT(γ,i)*=P-CNT(γ,i)/(J(γ,i) and N-CNT(γ,i) to N-CNT(γ,i)*=N-CNT(γ,i)/K(γ,i). In a block 144 I-Read may calculate a determining ratio R(P/N)=P-CNT(γ,i)*/N-CNT(γ,i)* and in a decision block 146 determines if the determining ratio is greater than a determining threshold D-TH((γ,i).

In an embodiment if in decision block 146 I-Read determines that determining ratio R(P/N) is greater than determining threshold D-TH(γ,i) I-Read optionally proceeds to a block 148 and determines that intention Int(γ,i) is present in the received email. If on the other hand I-Read determines that determining ratio R(P/N) is less than determining threshold D-TH(γ,i), I-Read optionally proceeds to a block 150 and determines that intention Int(γ,i) is not present in the received email.

There is therefore provided in accordance with an embodiment of the disclosure a method for determining an intention encoded in a given text communication, the method comprising: receiving a written text; identifying test regexes comprised in the text that are usable to indicate an intention included in the text; determining degrees of entailment of the test regexes with intention indicator regexes (IIRs) comprised in a set of IRRs; and inferring the intention based on the determined degrees of entailment. Optionally the method comprises determining IIRs belonging to the set of IRRs. Optionally determining the IRRs comprises using humans to select IRRs belonging to the set of IRRs. Additionally or alternatively, determining the IRRs comprises using a neural network to determine IRRs belonging to the set of IRRs.

In an embodiment identifying test regexes in the text comprises identifying regexes in the text that are similar to IRRs in the set of IRRs. In an embodiment identifying test regexes in the text comprises using a neural network to identify test regexes comprised in the text.

In an embodiment determining degrees of entailment comprises determining a degree of entailment for each of at least one regex of the identified test regexes with each of a plurality of IRRs selected from the set of IRRs. Optionally, the at least one of the at least one test regex includes all of the identified text regexes.

In an embodiment the set of IRRs comprises IRRs that are positively entailed and IRRs that are negatively entailed with a same test regex of the identified test regexes.

In an embodiment determining a degree of entailment between a test regex and a IRR comprises embedding both the test regex and the IRR in a same embedding space and determining a similarity between the embedments.

In an embodiment the method comprises determining a topic that is a subject of the communication. Optionally, determining degrees of entailment comprises determining degrees of entailment with IRR selected from the set of IRR that are associated with the subject of the communication.

There is further provided a communications network for determining an intention comprised in a communication propagated by the network, the system comprising: a hub for receiving copies of communications propagated by the network; and software comprising instructions executable to perform a method of inferring intentions of the communications in accordance with an embodiment of the disclosure.

Descriptions of embodiments of the disclosure in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A method for determining an intention encoded in a given text communication, the method comprising:
receiving a written text;
identifying test regexes comprised in the text that are usable to indicate an intention included in the text;
determining degrees of entailment of the test regexes with intention indicator regexes (IIRs) comprised in a set of IIRs;
and inferring the intention based on the determined degrees of entailment.

2. The method according to claim 1 and comprising determining IIRs belonging to the set of IIRs.

3. The method according to claim 2 wherein determining the IIRs comprises using humans to select IIRs belonging to the set of IIRs.

4. The method according to claim 2 wherein determining the IIRs comprises using a neural network to determine IIRs belonging to the set of IIRs.

5. The method according to claim 1 wherein identifying test regexes in the text comprises identifying regexes in the text that are similar to IIRs in the set of IIRs.

6. The method according to claim 1 wherein identifying test regexes in the text comprises using a neural network to identify test regexes comprised in the text.

7. The method according to claim 1 wherein determining degrees of entailment comprises determining a degree of entailment for each of at least one regex of the identified test regexes with each of a plurality of IIRs selected from the set of IIRs.

8. The method according to claim 7 wherein the of the test regex includes all of the identified text regexes.

9. The method according to claim 1 wherein the set of IIRs comprises IIRs that are positively entailed and IIRs that are negatively entailed with a same test regex of the identified test regexes.

10. The method according to claim 1 wherein determining a degree of entailment between a test regex and a IIR comprises embedding both the test regex and the IIR in a same embedding space and determining a similarity between the embedments.

11. The method according to claim 1 and comprising determining a topic that is a subject of the communication and related to the intention.

12. The method according to claim 11 wherein determining degrees of entailment comprises determining degrees of entailment with IIRs selected from the set of IIRs that are associated with the topic.

13. The method according to claim 12 wherein the selected IIRs comprise P-IIRs that are indicative of presence of the intention and N-IIRs that are indicative of absence of the intention.

14. The method according to claim 13 wherein determining degrees of entailment comprises determining a degree of entailment for each identified test regex with each of the selected P-IIRs and N-IIRs

15. The method according to claim 13 and comprising determining a first measure of a number of times that the degree of entailment of the identified test regexes with selected positive P-IIRs exceeds a positive entailment threshold.

16. The method according to claim 15 and comprising determining a second measure of a number of times that the degree of entailment of the selected test regexes with N-IIRs exceed a negative entailment threshold.

17. The method according to claim 16 wherein inferring the intention comprises inferring the intention based on the first and second measures.

18. A communications network for determining an intention comprised in a communication propagated by the network, the system comprising:
a hub for receiving copies of communications propagated by the network; and
software comprising instructions executable to perform the method of claim 1 to determine intentions of the communications.
